(19) United States
(12) Patent Application Publication
(10) Pub. No.: US 2026/0110550 A1
(43) Pub. Date: Apr. 23, 2026

(54) DISAGGREGATION AND DEMAND SIDE MANAGEMENT RESPONSE USING ADVANCED METERING INFRASTRUCTURE DATA

(71) Applicant: BIDGELY, INC., LOS ALTOS, CA (US)

(72) Inventors: A K Mayank, BANGALORE (IN); ALOORI RAJ ARYAN, TELANGANA (IN); BASANT KUMAR PANDEY, BENGALURU (IN); VIVEK GARUD, LOST ALTOS, CA (US)

(73) Assignee: BIDGELY, INC., LOS ALTOS, CA (US)

(21) Appl. No.: 19/230,491

(22) Filed: Jun. 6, 2025

Related U.S. Application Data
(60) Provisional application No. 63/635,680, filed on Apr. 18, 2024.

(51) Int. Cl. G01D 4/00

(52) U.S. Cl. CPC G01D 4/002; G01D 2204/10

(57) ABSTRACT

A method for providing real-time or near real-time insights or appliance identification and disaggregation using an advanced metering infrastructure (AMI) meter receiving energy usage data of a house and being in communication with a cloud-based processor, including: receiving at the cloud-based processor from the AMI meter, information identifying the AMI meter type or model or operating parameters; first energy usage data associated with the house; the cloud-based processor disaggregating at least some of the energy usage data, determining a home specific model (HSM); deploying the HSM on the AMI meter; receiving at the cloud-based processor information from the AMI meter indicating that the current HSM is not applicable to or capable of disaggregating second energy usage data; analyzing or disaggregating second energy usage data by the cloud-based processor; determining modifications or improvements to the HSM; deploying modifications or improvements to the HSM to the AMI meter.

### RELATED APPLICATIONS.

The present application claims priority to U.S. Provisional Patent Application No. 63/635,680, filed 18 Apr. 2024 entitled “Improving Disaggregation and Demand Side Management Response using Advance Metering Infrastructure Data,” which is incorporated by reference herein in its entirety.

### BACKGROUND.

In general, the present invention is directed to the use of data from Advanced Metering Infrastructure (AMI) devices to improve disaggregation results and assist in Demand Side Management (DSM) responses. More specifically, the present invention utilizes both historical data from an AMI device and real-time or near real-time data from an AMI device to assist with disaggregation and appliance determination. Real-time or near real-time data utilized may comprise information or granularity of information not typically recorded or shared by AMI devices. Such data may assist in determining and providing real-time or near real-time insights and alerts for improved energy consumption analyses and/or outcomes.

Electricity consumption monitoring and management have become increasingly crucial for both utility providers and consumers. Historical AMI data has proven valuable for understanding long-term consumption patterns, particularly when used as training data for various disaggregation algorithms and approaches. However, circumstances may occur when a complete disaggregation cannot be performed, or confidence in identified appliance types, loads, etc. is low. In such circumstances, additional information or data may assist in completing the disaggregation. Such additional information or data may comprise data that is not part of the typically-recorded energy consumption data or a more specific granularity of data. For example, additional information may comprise, but is not limited to, characteristics such as voltage, current, power factor, and/or phase information. Such additional information and data may be provided at various sampling frequencies—such as data sampled every one (1) second or higher, or even at a sub-second level.

In current prior art systems, data is generally unavailable at real time and therefore fast paced actions generally cannot be taken. Moreover, AMI data at the typically utilized fifteen (15) minute granularity may produce a similar signal for multiple appliances, which may make it more difficult to differentiate between them.

However, current AMI devices and meters may be capable of detecting, obtaining, and/or recording multiple parameters other than general consumption. However, it is challenging to process this data on the meter due to limitations on both storage (memory) and the ability to process or compute such data. Because of compute limitations, AMI devices generally are unable to run or process modern machine learning algorithms. Because of storage limitations, AMI devices generally are unable to look at a longer time frame of data (for example, such meters generally cannot look for a pattern that repeats at the same time every day). In addition, due to network limitations, it is difficult to transfer all high frequency (or higher granularity) data for subsequent analytics and/or processing, for example utilizing the Internet or other cloud-based networks.

Such information—if captured by a meter—is typically provided to a remote or distributed processor for analysis. This remote, often in-cloud (vs. “on meter”) processing has several drawbacks and disadvantages. For example, data is generally available after a several hour delay, thereby eliminating any opportunity for quick reactions to changing conditions (as may be indicated by real-time or near real-time data). As noted above, meter data sampling is typically limited to fifteen (15) minute frequency sampling, which may make it harder to differentiate between two appliances that consume similar amounts of energy. These same appliances may be distinguished if access to more granular data was available.

In-cloud disaggregation based on AMI meter data may also present additional drawbacks. For example, data is generally sampled at low rates, and therefore a large number of occurrences of an appliance is often needed before a system or algorithm can start accurately and consistently detecting and/or disaggregating such appliance usage. This may become especially challenging for appliances that either run infrequently (for example, a dehumidifier which may only be occasionally operated) or air conditioning equipment in certain weather zones.

Accordingly, it may be desirable to integrate real-time data from the premises in an effort to provide more immediate insights and help optimize energy usage efficiently. It may be further desirable to integrate information extracted from historical AMI data for a user and real time activity on the premise to provide real time insights and alerts to the user.

### SUMMARY OF THE INVENTION.

In accordance with some embodiments of the present invention, aspects may include a method for providing real-time or near real-time insights or appliance identification and disaggregation, using an advanced metering infrastructure (AMI) meter receiving energy usage data of a house, and being in communication with a cloud-based processor, the method comprising: receiving at a cloud-based processor data from the AMI meter, the data comprising: information sufficient to identify the AMI meter type or model and one or more operating parameters; first energy usage data associated with the house; the cloud-based processor disaggregating at least some of the energy usage data associated with the house, and based at least in part on the AMI meter, determining a home specific model (HSM); deploying the HSM on the AMI meter; receiving at the cloud-based processor information from the AMI meter indicating that the current HSM is not applicable to or capable of disaggregating second energy usage data; analyzing or disaggregating second energy usage data by the cloud-based processor; determining modifications or improvements to the HSM; deploying modifications or improvements to the HSM to the AMI meter.

In accordance with some embodiments of the present invention, aspects may include a method providing real-time or near real-time insights or appliance identification and disaggregation, using an advanced metering infrastructure (AMI) meter receiving energy usage data of a house, and being in communication with a cloud-based processor, the method comprising: receiving at a cloud-based processor data from the AMI meter, the data comprising: information sufficient to identify the AMI meter type or model and one or more operating parameters; first energy usage data associated with the house; the cloud-based processor disaggregating at least some of the energy usage data associated with the house, and based at least in part on the AMI meter, determining a home specific model (HSM); deploying the HSM on the AMI meter; receiving real-time or near real-time energy usage data associated with the house at the AMI meter and applying the HSM to analyze or disaggregate the energy usage data in real-time or near real-time; iteratively learning and modifying the HSM based on information received or disaggregated by the AMI meter; receiving at the cloud-based processor information from the AMI meter indicating that the current HSM is not applicable to or capable of disaggregating second energy usage data; analyzing or disaggregating second energy usage data by the cloud-based processor; determining modifications or improvements to the HSM; deploying modifications or improvements to the HSM to the AMI meter; providing a user device or a utility with real-time or near real-time insights into energy usage of the house.

The foregoing summary is only illustrative in nature and is not intended to be in any way limiting. In addition to the illustrative aspects, embodiments, and features described above, further aspects, embodiments, and features will become apparent by reference to the drawings and the following detailed description.

### DESCRIPTION OF THE DRAWINGS.

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 sets forth a general arrangement in accordance with some embodiments of the present invention.

FIG. 2 illustrates an exemplary process in accordance with some embodiments of the present invention.

FIG. 3 exemplary back-and-forth communications according to some embodiments of the present invention.

FIG. 4 sets forth a general arrangement between entities that may utilize the present invention, in accordance with some embodiments of the present invention.

FIG. 5 depicts a system arrangement in accordance with some embodiments of the present invention.

FIG. 6 illustrates an exemplary flow chart, in accordance with some embodiments of the present invention.

### DETAILED DESCRIPTION.

Before any embodiment of the invention is explained in detail, it is to be understood that the present invention is not limited in its application to the details of construction and the arrangements of components set forth in the following description or illustrated in the drawings. The present invention is capable of other embodiments and of being practiced or being carried out in various ways. Also, it is to be understood that the phraseology and terminology used herein is for the purpose of description and should not be regarded as limiting.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure. In addition, note that the order of steps of any process or method discussed herein or illustrated in the figures is exemplary and not to be construed as limiting.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments. The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

This document may use the phrase “real-time” or “near real-time.” It is noted that the intent of these terms is to indicate a streaming use of such data, without significant storage, residual storage times, or latency in processing. The terms are used to indicate a timely use of the data but shall not be construed to require a literal “immediate” processing of all data.

In accordance with some embodiments of the present invention, historical AMI data may be used for overall disaggregation of appliances using which one or more models. For example, when the process first begins a general model may be utilized, which may act as a starting point, or initialization point for “on meter” disaggregation. Such general model may be based on home demographics (size, weather zone, known attributes (pool, etc.). Once the information from the specific home is received and processed, a home specific model (HSM) may be created. On meter disaggregation is the application of a disaggregation algorithm at the meter level, using real-time or near real-time data. For example, amplitude measurement and appliance classification may be done on the fly. Data and disaggregation results may be utilized to update the HSM. Using a combination of historical and real-time meter data may reduce the overall infrastructure requirement at the meter, thereby making AMI meters far more capable than what is currently possible with locally available resources and/or more cost effective.

An iterative self-learning algorithm that may improves over time by identifying consumption patterns at home level may be utilized, educated first by historical data and then updated using real-time or near-real time data and/or data with increased frequency or granularity. Instances of appliance usage may be classified on a real-time or near real-time basis, providing the ability to offer immediate insights, which may assist utilities to understand and manage load on the transformers grid, as well as improve customer satisfaction by providing more control over energy consumption.

In accordance with some embodiments of the present invention, historical AMI data may first be leveraged to perform an overall disaggregation of appliances, thereby creating the preliminary home specific model (HSM). This may be based at least in part on several months of AMI data for the specific home, and may be supplemented by additional data from third party sources, public records, neighborhood demographics, survey data, weather zones and/or patterns, etc. Therefore, the learning time required for the on-meter module before it can start detecting appliances in real-time may be vastly reduced. The output of this model serves as an initialization point for the self-learning On Meter Disaggregation Algorithm.

Once applied to the meter, the On Meter Disaggregation Algorithm may then classify instances of appliance usage in real-time or near real-time. This may involve amplitude measurement and appliance classification performed dynamically, while the household-specific model is continually updated to facilitate the next alert. In accordance with some embodiments, a self-learning algorithm, referred to as the “On Meter Method,” may be stored on an AMI device and utilized to classify instances of appliance usage on a real-time or near real-time basis. The “On Meter Method” may evolve over time by discerning consumption patterns at the household level. The On-meter module may capture data features that may be only seen on the meter, summarize them into a small enough size packet that can be sent over to the on-cloud module. This enhances the capability of the on-cloud module to disaggregate more appliances and at a higher level of accuracy.

In accordance with some embodiments of the present invention, an entity (such as a utility or an aggregator) may have greater control over distributed energy resources (DERs) behind the meter. In this manner, by managing a network of decentralized power generating units (such as various inputs from solar, wind, energy storage devices, etc.) may be controlled as a virtual power plant (VPP) to protect distribution transformers or avoid tripping protection devices. This may permit a maximized range of provision or consumption while still protecting grid elements.

For example, if the entity has visibility only to DERs but not to real-time data of increased loads, such as electric vehicle (EV) charging, the entity may either act too conservatively to avoid tripping/overload scenarios, or act too rashly bringing about such tripping/overload scenarios. Utilizing some embodiments of the present invention, an entity may have visibility to both DERs and also to real-time consumption data with specific awareness to impactful appliances or energy loads (such as but not limited to EV charging).

Accordingly, utilities may use actual appliance penetration to update models of load growth on feeders and identify systematic problems in distribution system (e.g. areas of high voltage areas that may correlate with solar penetration; areas of low voltage areas that may correlate with a large increase in EV charging demand; etc.). This data can be used to establish capital projects across a utility system. EV programs may be used to determine to areas or premises that are showing EV adoption, and may either encourage more EV adoption or providing benefits through direct or indirect control of EV charging to mitigate impact on the grid.

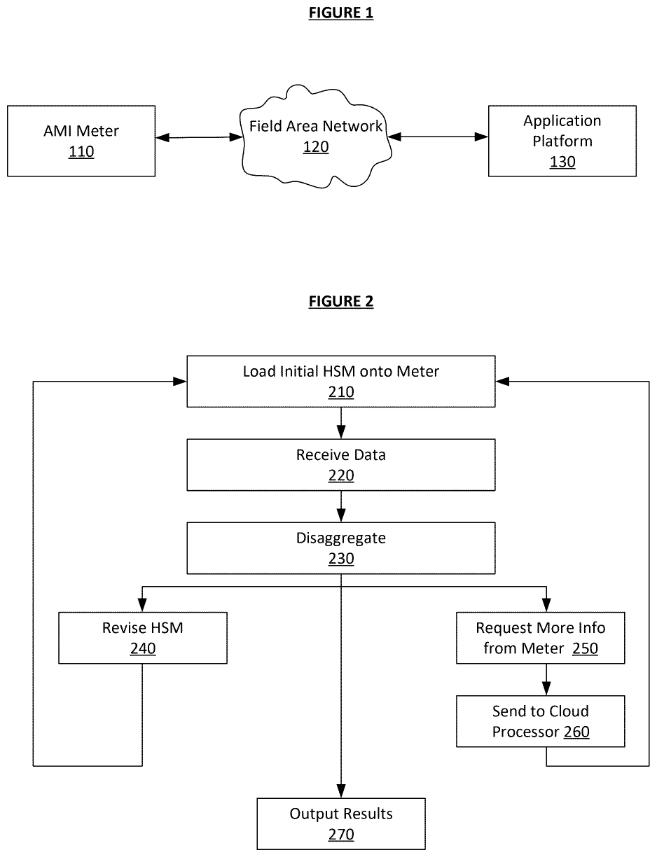

With reference to FIG. 1, a general arrangement in accordance with some embodiments of the present invention is illustrated. It can be seen that an AMI meter 110 may be in communication with an application platform 130, for example via the internet or a field area network 120. A field area network may be utilized to consolidate disparate communication networks used between AMI devices and application platform 130. Field Area Networks may comprise any component or combination of Ethernet, WiFi, WiMax, 4G/LTE communications (or other wireless broadband), Radio frequency (RF) or power line communication (PLC) mesh, low-power wide area (LPWA) networks, FTTP/FTTH/FTTB/FTTX, and/or other types of communication. Devices that may support a field area network may include, but are not limited to routers (including field area routers (FARs)), gateways, range extenders, mesh network devices and endpoints, etc.

With reference to FIG. 2, an exemplary process in accordance with some embodiments of the present invention will now be discussed. At 210 an initial home specific model (HSM), which may be developed based on historical data, may be loaded on the AMI meter. At 220, real-time or near real-time meter data may be received at the AMI meter. At 230 the AMI meter may seek to apply the HSM to disaggregate the data. There may be at least three (3) outputs from the HSM. At 240 the results may be used to revise the HSM, which may then be reapplied to the AMI meter. At 250 the AMI meter may be unable to complete all or some disaggregation and may capture additional information, and send it to the cloud processor at 260. The cloud processor may utilize this data to complete disaggregation and may revise the HSM, which may be reapplied to the AMI meter. The AMI meter may also output its disaggregation results at 270.

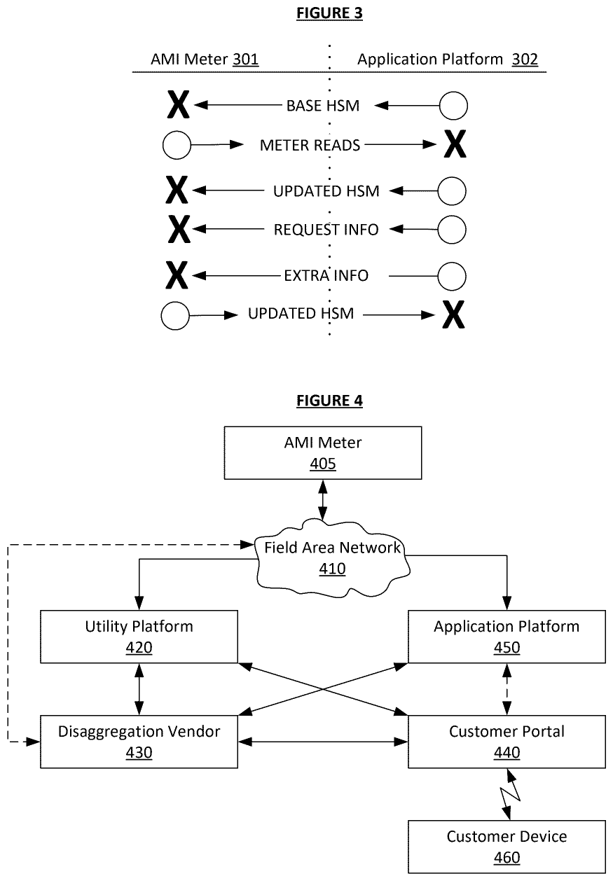

With reference to FIG. 3, an exemplary back-and-forth communications between the AMI meter 301 and the cloud based application platform 302, according to some embodiments of the present invention, is graphically illustrated. For example, in accordance with some embodiments the cloud based application platform 302 may send real-time or near real-time alerts or information to the AMI meter 301, for example, information related to a sudden weather event, etc. Such events may require a quick modification of the on-meter HSM to properly handle data that may be generally, outside of the expected range (such as in a sudden extreme weather event).

At 310 the initial HSM is sent from the application platform 302 to the AMI meter 301. At 320 meter reads from the AMI meter 301 may be send to the application platform 302. Note that the meter reads from the AMI meter 301 may also be used, on-meter, to make real-time or near real-time disaggregation decisions.

In some embodiments, raw meter reads may be less than desirable to send to the application platform 302. In such circumstances, features may be extracted from the meter reads by the AMI meter 301, and such features may be sent to the application platform 302. In other words, the AMI meter 301 may send raw data, partially or fully processed data, and/or extracted data (such as features, patterns, etc.) to the application platform 302.

At 330 an updated HSM may be sent back to the AMI meter 301. At 340, the application platform 302 may request additional information from the AMI meter 301. At 350, the AMI meter may send back additional data.

In addition to the back-and-forth exchange of information, it is also contemplated by some embodiments of the present invention that the unsolicited information may be sent from the AMI meter 301 to the application platform 302, or from the application platform 302 to the AMI meter 301. For example, the AMI meter 301 may determine information outside of normal expected ranges and may send that, unsolicited, to the application platform 302. This may assist grid management by having a real-time or near real-time input of unusual conditions from the edge. Similarly, the application platform 302 may send model updates, information regarding sudden weather events or conditions, and/or other information unsolicited to the AMI meter 301.

The exchange of information and processing between the AMI meter (being “on the edge”) and the application platform (being “in the cloud”) causes the system to operate in two manners, depending on the flow of information. When the on-meter algorithm is running, the AMI meter may be operating as an edge device, bringing computation and data storage at the edge of the network. However, there are times when the application platform requests additional information that can be captured by the AMI meter. In this situation, the AMI meter may act more as a component of fog computing, by extending services and connectivity to edge devices. This dual use of the system may permit more timely and accurate results while keeping AMI meter infrastructure costs and requirements low.

With referent to FIG. 4, a general arrangement between entities that may utilize the present invention, in accordance with some embodiments of the present invention, is illustrated. An AMI meter 405 may communicate with a field area network 410, which in turn may communicate with a utility platform 420 and an application platform 450 and may potentially communicate with a disaggregation vendor 430. The disaggregation vendor 430 may be in communication with the utility platform 420, the application platform 350, and potentially with a customer portal 440. The utility platform 420 may communicate with the disaggregation vendor 430 and the customer portal 440. The application platform 450 may communicate with the disaggregation vendor 430 and potentially with the customer portal 440. The customer portal 440 may convey information to one or more customer devices 460.

The utility platform 420 may be run by a utility. The disaggregation vendor 430 may be a third party outside of the utility who may receive AMI data and disaggregate the information into specific appliances or types of appliances, conveying the same information either back to the utility 420 (where it may be shared to customers via the customer portal 440), or directly to the customer portal. The disaggregation vendor 430 may supply the initial home specific model (HSM), which may be based at least in part on historical AMI meter data, stored by the utility 420, the disaggregation vendor 430, and/or other third party datastores. The application platform 450 may provide the interface between the AMI meter 305 and other parties.

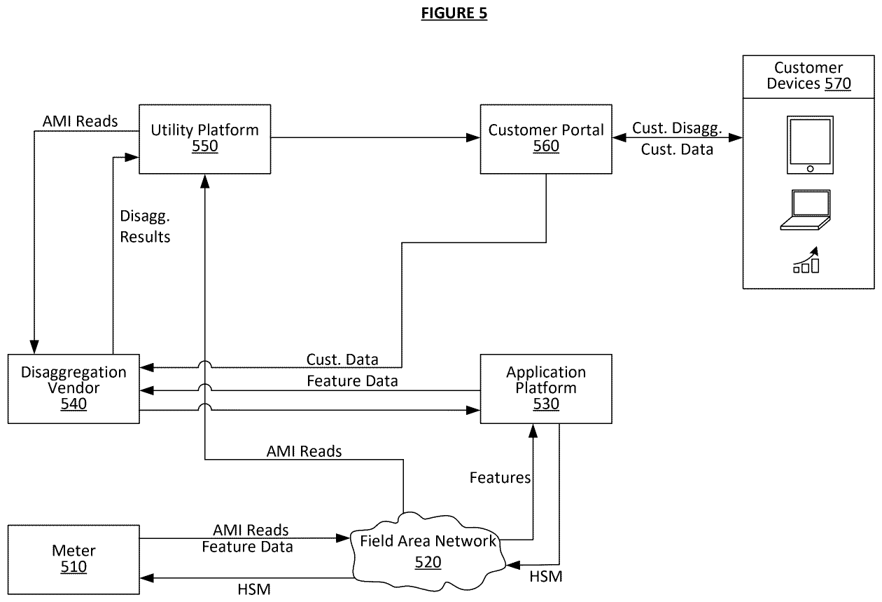

With reference to FIG. 5, a system arrangement in accordance with some embodiments of the present invention will now be discussed. Some systems may comprise a meter 510, which may be in communication with a field area network 520. The meter 510 may receive a home specific model (HSM) from the field area network 520, and may provide the field area network 520 with AMI meter reads and/or feature data.

The field area network 520 may send AMI meter reads to a utility platform 550 and may send feature data to an application platform 530. The field area network may receive a HSM from the application platform.

The utility platform 550 may receive the AMI meter reads from the field area network 520 and may send the same to a disaggregation vendor 540. The disaggregation vendor 540 may disaggregate the data from the AMI meter reads and provide the same back to the utility platform 550, which may be conveyed to a customer portal 560. The disaggregation vendor 540 may also communicate with the application platform 530, both receiving feature data from the application platform 530 and sending back revised HSM based on disaggregated and analyzed data.

The customer portal 560 may send information back and forth to a customer device (which may comprise a computer, smart phone, tablet, etc.), and may provide customer data back to the disaggregation vendor 540. This customer data may also comprise information obtained from the customer that may be useful in disaggregating data (such as what appliances the customer owns, or what appliance was running at a specific time).

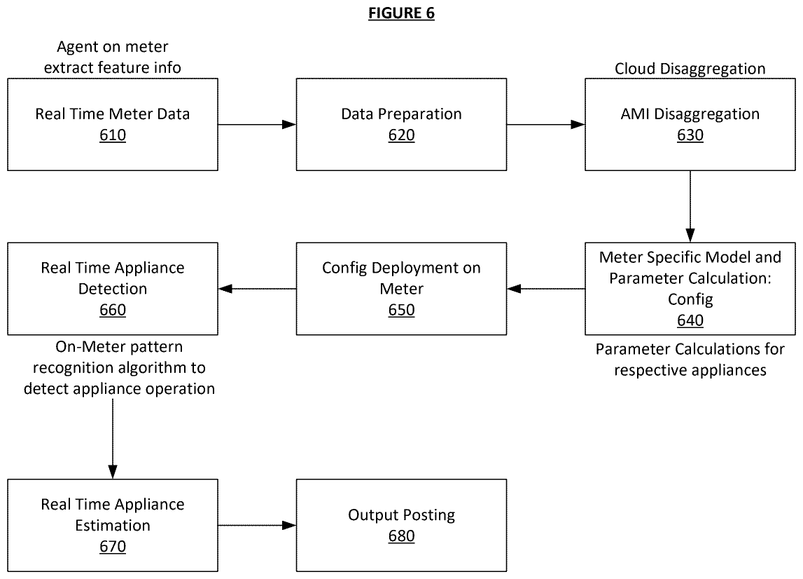

With reference to FIG. 6, a general flow chart in accordance with some embodiments of the present invention will be discussed. At 610 real-time or near real-time meter data is received at a meter. An agent on the meter may extract feature information. At 620 the feature extraction and/or meter data is prepared and sent at 630 to the cloud for AMI disaggregation. The home specific model, with corresponding parameters may be updated at 640, and a specific configuration may be deployed on the meter at 650. At 660 the on-meter algorithm may detect appliance operation and make, at 670 a real-time or near real-time appliance estimation. This may be output at 680.

In this manner, integration of historical AMI data and real-time activity data, along with the use of the On Meter Method, provides a novel approach to providing real-time insights and alerts for improved energy consumption analysis. For example, real-time or near real-time alerts may be sent to a customer to notify if an appliance is being used during hours of a high rate or tariff. Alerts may even be actionable, for example in the case of managed charging of EVs, where alerts may be received and processed, and charging paused, rescheduled, changed, etc. by a remote program.

This innovation offers benefits in terms of cost-effectiveness, grid load management, user satisfaction, and scalability to other appliances. It also incorporates a broader range of data parameters for comprehensive energy management.

It will be understood that the specific embodiments of the present invention shown and described herein are exemplary only. Numerous variations, changes, substitutions and equivalents will now occur to those skilled in the art without departing from the spirit and scope of the invention. Accordingly, it is intended that all subject matter described herein and shown in the accompanying drawings be regarded as illustrative only, and not in a limiting sense.

What is claimed is:

1. A method for providing real-time or near real-time insights or appliance identification and disaggregation, using an advanced metering infrastructure (AMI) meter receiving energy usage data of a house, and being in communication with a cloud-based processor, the method comprising:
receiving at a cloud-based processor data from the AMI meter, the data comprising:
information sufficient to identify the AMI meter type or model and one or more operating parameters;
first energy usage data associated with the house;
the cloud-based processor disaggregating at least some of the energy usage data associated with the house, and based at least in part on the AMI meter, determining a home specific model (HSM);
deploying the HSM on the AMI meter;
receiving at the cloud-based processor information from the AMI meter indicating that the current HSM is not applicable to or capable of disaggregating second energy usage data;
analyzing or disaggregating second energy usage data by the cloud-based processor;
determining modifications or improvements to the HSM;
deploying modifications or improvements to the HSM to the AMI meter.

2. The method of claim 1, wherein the HSM iteratively learns and modifies itself based on information received or disaggregated by the AMI meter.

3. The method of claim 2, wherein the information received or disaggregated by the AMI meter comprises identification of specific appliances in the house.

4. The method of claim 2, wherein the information received or disaggregated by the AMI meter comprises information received from a user-device providing house-specific or user-specific information.

5. The method of claim 1, further comprising receiving energy usage data for the house and performing real-time or near real-time analysis and disaggregation on the energy usage data utilizing at the AMI meter using the HSM.

6. The method of claim 5, further comprising providing a user device or a utility with real-time or near real-time insights into energy usage of the house.

7. The method of claim 5, wherein AMI meter communicates with the cloud-based processor via a field area network.

8. The method of claim 1, wherein the cloud-based processor determining modifications or improvements to the HSM are based at least in part on information requested from and received from a user device.

9. A method providing real-time or near real-time insights or appliance identification and disaggregation, using an advanced metering infrastructure (AMI) meter receiving energy usage data of a house, and being in communication with a cloud-based processor, the method comprising:
receiving at a cloud-based processor data from the AMI meter, the data comprising:
information sufficient to identify the AMI meter type or model and one or more operating parameters;
first energy usage data associated with the house;
the cloud-based processor disaggregating at least some of the energy usage data associated with the house, and based at least in part on the AMI meter, determining a home specific model (HSM);
deploying the HSM on the AMI meter;
receiving real-time or near real-time energy usage data associated with the house at the AMI meter and applying the HSM to analyze or disaggregate the energy usage data in real-time or near real-time;
iteratively learning and modifying the HSM based on information received or disaggregated by the AMI meter;
receiving at the cloud-based processor information from the AMI meter indicating that the current HSM is not applicable to or capable of disaggregating second energy usage data;
analyzing or disaggregating second energy usage data by the cloud-based processor;
determining modifications or improvements to the HSM;
deploying modifications or improvements to the HSM to the AMI meter;
providing a user device or a utility with real-time or near real-time insights into energy usage of the house.

10. The method of claim 9, wherein the information received or disaggregated by the AMI meter comprises identification of specific appliances in the house.

11. The method of claim 9, wherein AMI meter communicates with the cloud-based processor via a field area network.

12. The method of claim 9, wherein the cloud-based processor determining modifications or improvements to the HSM are based at least in part on information requested from and received from a user device.
